(19) United States
(12) Patent Application Publication
(10) Pub. No.: US 2006/0272927 A1
(43) Pub. Date: Dec. 7, 2006

(54) Intake feeding for agricultural vacuum conveyors

(76) Inventors: Timothy Earl Baber, Regina (CA); Don Grant Vass, Regina (CA); Cameron Dwight Bodie, Moose Jaw (CA); Jonathan Robert Carteri, Regina (CA)

Correspondence Address: FROST BROWN TODD, LLC, 2200 PNC CENTER, 201 E. FIFTH STREET, CINCINNATI, OH, 45202, US

(21) Appl. No.: 11/432,990

(22) Filed: May 12, 2006

(30) Foreign Application Priority Data
Feb. 26, 2006 (CA) 2,537,580
May 19, 2005 (CA) 2,507,942

(51) Int. Cl. B65G 15/42

(52) U.S. Cl. 198/689.1

(57) ABSTRACT

An agricultural vacuum conveyor feeding apparatus includes a vacuum conduit having a first end thereof adapted for attachment to a suction port on a vacuum conveyor, and an intake nozzle defining an intake opening on a second end thereof. A material conveying member such as a rotating auger or a scoop extends outward from the intake end of the vacuum conduit and is operative to move granular material toward the intake opening of the intake nozzle when moved through a quantity of granular material. The material conveying member is attached to the intake nozzle such that the intake nozzle moves to follow the material conveying member as the material conveying member moves granular material toward the intake opening. In one embodiment the intake nozzle and material conveying member are fixed to a vacuum conveyor and moved by moving the vacuum conveyor.

This invention is in the field of vacuum conveyors, and in particular feeding the intake of such conveyors.

### CROSS REFERENCE TO RELATED APPLICATIONS

This application claims priority to Canadian Patent Application Serial No. 2,537,580, filed Feb. 26, 2006 and to Canadian Patent Application Serial No. 2,507,942, filed May 19, 2005.

### BACKGROUND OF THE INVENTION

Moving agricultural products such as grain, and analogous products such as peas, beans, and the like requires that the grain be conveyed from storage bins into transport vehicles. Such storage bins can conveniently be provided with hoppered floors so that the grain will conveniently flow into an auger or belt conveyor. Often however the floor is flat and so the grain must be moved along the floor to a conveyor intake. Similarly, agricultural products are often stored in piles on the ground.

Sweep augers are well known for moving agricultural products along a flat surface to an auger intake. Such sweep augers typically comprise a length of auger flighting pivotally attached at one end to the intake end of an auger conveyor, or over a central sump in a bin floor. The opposite end of the sweep auger moves in an arc around the intake and as the flighting rotates it moves grain to the intake and the grain is conveyed away. The rotation of the sweep auger typically moves the flighting along the floor such that same sweeps in an arc with little attention from an operator, moving grain into the conveyor intake.

Portable pneumatic or vacuum conveyors are also well known for use in conveying agricultural products. These machines allow pickup of grain from a flat floor or the ground with a nozzle on the end of a flexible hose that allows considerable freedom of movement. A fan or air pump is used to establish a flow of air from the nozzle through the hose and through the machine to a discharge. When the nozzle is placed into the grain, the flow of air is substantially blocked, and so an adjustable vent is provided on the intake nozzle so that air can enter the nozzle and maintain the flow of granular material. The intake nozzle is placed in the grain, which in a flat floor bin slopes upward to the bin walls. The grain flows down the slope until the angle of repose of the grain is reached, at which time the nozzle must be moved slightly to start the grain flowing again.

The nozzle can be quite heavy, and since same must be moved frequently to maintain the flow of grain, various mechanisms have been developed to relieve the operator. For example Canadian Patent Number 2,307,055 to Close discloses a nozzle with a handle and wheels supporting same on the floor such that the operator can roll the nozzle across the floor to maintain the flow of grain into the nozzle.

Vacuum conveyor feeding is disclosed in U.S. Pat. No. 3,319,809 to Prentice and in U.S. Pat. No. 5,351,805 to Miller et al. where augers are mounted under the intake of a vertically oriented vacuum conveyor and move in a circle under the intake to move granular material to the intake while the intake remains stationary.

### SUMMARY OF THE INVENTION

It is an object of the present invention to provide a vacuum conveyor feeding apparatus that overcomes problems in the prior art.

The present invention provides in a first embodiment a vacuum conveyor feeding apparatus comprising a vacuum conduit having a first end thereof adapted for attachment to a suction port on a vacuum conveyor, and an intake nozzle defining an intake opening on a second end thereof. A material conveying member extends outward from the intake end of the vacuum conduit and is operative to move granular material toward the intake opening of the intake nozzle when moved through a quantity of granular material. The material conveying member is attached to the intake nozzle such that the intake nozzle moves with the material conveying member as the material conveying member moves granular material toward the intake opening.

In a second embodiment the invention provides a vacuum conveyor and feeding apparatus comprising a vacuum conveyor mounted on wheels for travel in an operating travel direction and a feed arm extends laterally outward from the vacuum conveyor. A vacuum conduit has a first end thereof attached to a suction port on the vacuum conveyor, and has an intake nozzle defining an intake opening on a second end thereof. The intake opening is positioned adjacent to an outer end of the feed arm. A material conveying member extend outward from an outer end of the feed arm in a substantially fixed lateral position with respect to the vacuum conveyor and is operative to move granular material toward the intake opening when moved through a quantity of granular material by moving the vacuum conveyor in the operating travel direction. At least one gauge member is attached to the material conveying member and is operative to support the material conveying member above the ground.

In a third embodiment the invention provides a method of feeding granular material into a vacuum conveyor mounted on wheels for travel in an operating travel direction. The method comprises attaching an output end of a vacuum conduit to the vacuum conveyor; attaching a material conveying member to an intake end of the vacuum conduit such that the material conveying member extends outward from the intake end of the vacuum conduit in a substantially fixed lateral position with respect to the vacuum conveyor; and moving the material conveying member through a quantity of granular material by moving the vacuum conveyor in the operating travel direction and thereby moving at least a major portion of the granular material to the intake end of the vacuum conduit.

The vacuum conveyor feeding apparatus can comprise a sweep auger pivotally attached to one side of the intake end of a vacuum conveyor nozzle. When initially placing the intake of the nozzle into a pile of grain, the auger is positioned alongside and parallel to the nozzle. Initially grain may flow into the nozzle for some time without moving same, and so the auger is stationary. As the flow dwindles, a drive motor on the distal end of the auger is turned on to rotate the auger which draws grain along the auger to the intake and out through the nozzle.

As the grain pile is carried away from the location of the auger, the auger swings outward from the position parallel to and alongside the nozzle into the remaining grain in the pile, and continues to move into the grain through about 180 degrees until it reaches a location substantially aligned with the nozzle and extending outward therefrom. At that point the two must move together into the grain pile to move any further grain to the intake. The auger will tend to move into the grain pile on its own, and can be assisted by an operator as required. Relatively little attention is required by the operator in comparison to the almost constant manipulation required by a conventional vacuum conveyor nozzle apparatus.

Commercially available vacuum conveyors for use in agriculture typically are mounted on a trailer pulled behind and powered by an agricultural tractor. Where grain is piled on the ground, such a conveyor can be used in conjunction with the present invention to convey grain from piles on the ground. Typically such piles are picked up by auger or vacuum conveyors in a conventional manner. Where an auger conveyor is used, a sweep auger may be used to convey grain to the conveyor intake, in the same manner as grain on a flat bin floor. Alternatively such piles also allow a front end loader bucket on a tractor to be used to push the grain into the intake. Where a vacuum conveyor is used, the intake nozzle is manipulated conventionally as in a grain bin to maintain the flow of grain into the intake.

With the present invention, the auger can be locked in place extending substantially straight out from the intake nozzle of a vacuum conveyor pulled behind a tractor. The intake nozzle and the conduit carrying the grain from the nozzle to the conveyor are also locked in place extending laterally out from the vacuum conveyor. Gauge wheels or skids are mounted on the auger such that same can move readily along the ground, and the tractor is driven alongside the grain pile to move the auger and nozzle into the grain. As the grain is carried away the pile recedes and the tractor is driven along as required to maintain flow into the nozzle intake.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of an embodiment of the vacuum conveyor feeding apparatus of the invention in an initial position;

FIG. 2 is a perspective view of the embodiment of FIG. 1 in an intermediate position;

FIG. 3 is a perspective view of the embodiment of FIG. 1 in a fully extended position;

FIG. 4 is a perspective view of an alternate embodiment of the vacuum conveyor feeding apparatus for cleaning up piles of grain on the ground;

FIG. 5 is a rear view of the embodiment of FIG. 4;

FIG. 6 is a top view of the embodiment of FIG. 4;

FIG. 7 is a front view of the embodiment of FIG. 4 in the normal working position;

FIG. 8 is a front view of the embodiment of FIG. 4 partially raised to the transport position;

FIG. 9 is a front view of the embodiment of FIG. 4 in the transport position;

FIG. 10 is a front view of the embodiment of FIG. 4 in a position for working over a wall;

FIG. 11 shows an alternate embodiment using a scoop as the material conveying member for cleaning up piles of grain on the ground;

FIG. 12 is a schematic end view of the scoop of FIG. 11.

### DETAILED DESCRIPTION OF THE ILLUSTRATED EMBODIMENTS

The vacuum conveyor feeding apparatus of the invention comprises a vacuum conduit having a first end thereof adapted for attachment to a suction port on a portable agricultural vacuum conveyor, and an intake nozzle defining an intake opening on a second end thereof. A material conveying member extends outward from the intake nozzle and is operative to move granular material toward the intake opening of the intake nozzle when moved through a quantity of granular material. The material conveying member is attached to the intake nozzle such that the intake nozzle must move with the material conveying member in order for the material conveying member to move granular material toward the intake opening.

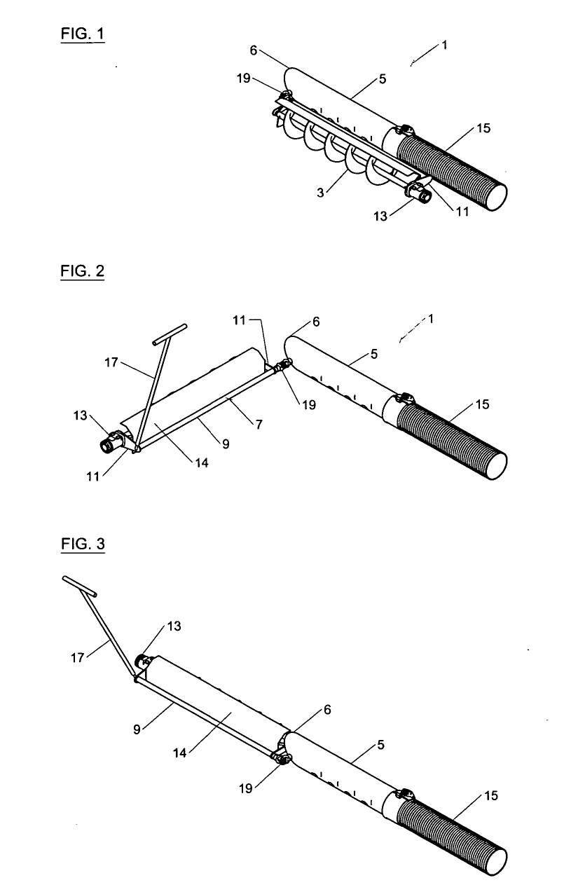

FIGS. 1-3 illustrate a vacuum conveyor feeding apparatus 1 of the invention wherein the material conveying member comprises a sweep auger 3 attached to the intake nozzle such that the auger is oriented in an extended position extending outward from the intake opening and substantially aligned with a longitudinal axis of the intake nozzle as illustrated in FIG. 3.

For convenience in initially placing the apparatus 1 in a grain bin, the auger 3 is pivotally attached to one side of the intake end of an intake nozzle 5 of a vacuum conduit 15. The auger 3 is mounted on an auger frame 7 comprising a rear frame member 9 and brackets 11 extending forward from each end of the rear frame member 9. A discharge end of the auger 3 is rotatably mounted in the bracket 11 at the inner end of the auger frame 7 adjacent to the intake opening 6 and a distal end of the auger 3 is rotatably mounted in bracket 11 at the distal end of the auger frame 7. The auger 3 is mounted to the brackets 11 by bearings, and a drive motor 13 is mounted on the bracket 11 at the distal end of the frame 7 and is connected to the shaft of the auger 3 to drive the same. A rear shroud 14 extends upward and partway over the auger 3 along the rear side thereof to improve the efficiency of grain movement by the auger 3.

The motor 13 will typically be a hydraulic or electric motor, and hydraulic hoses or electrical wires will run from a source on the tractor operating the conveyor down the vacuum conduit 15 along the nozzle 5 and then along the frame 7 to the motor 13. A handle 17 may also be provided extending upward from the frame to facilitate manipulating the auger 3 as required. Conveniently the handle 17 is configured so same can be readily removed when not required.

In the illustrated embodiment a universal joint 19 is attached to the inside end of the rear frame member 9 at one end and to the left side of the nozzle 5 in proximity to the open intake end 21 of the nozzle 5 such that the frame 7 and auger 3 can pivot horizontally, about a first pivot axis transverse to the longitudinal axis of the intake nozzle 5, from the position of FIG. 1 to the position of FIG. 2 to the position of FIG. 3. The universal joint 19 also conveniently allows the auger 3 to pivot about a second pivot axis transverse to the first pivot axis such that the auger 3 can move vertically to allow the intake nozzle to be oriented at an upward angle from the floor of a bin.

With the illustrated configuration, the auger 3 can be positioned as illustrated in FIG. 1 when initially placing the intake opening 6 of the nozzle 5 into a pile of grain. Typically grain will then flow into the nozzle 5 for some time without moving same, and so the auger 3 is stationary. As the flow dwindles, the drive motor 13 is turned on to rotate the auger 3 and grain is conveyed along the auger 3 to the intake opening 6 and out through the nozzle 5 and conduit 15.

As the grain pile is carried away from the location of the auger 3, the auger swings outward from the position of FIG. 1, parallel to and alongside the nozzle 5, into the remaining grain in the pile, and continues to move into the grain through the intermediate position of FIG. 2 and through about 180 degrees until it reaches the location of FIG. 3 where the auger 3 is in the extended position substantially aligned with the nozzle 5 and extending outward therefrom. At that point the auger frame 7 bears against the nozzle 5 and in order to move any further grain with the auger 3 the intake nozzle 5 must move with the auger 3. The auger 3 will tend to move into the grain pile on its own bringing the nozzle 5 with it, and can be conveniently assisted by an operator with the handle 17 as required.

By mounting the auger 3 on a front side of the frame 7, and mounting the inside end of the rear frame member 9 to the universal joint 19 extending from the side of the nozzle 5, the directly aligned position of the auger 3 and the intake opening 6 of the nozzle 5 is attained.

In configuring a conventional sweep auger for use with an auger conveyor, the sweep auger must create a pile of grain over the auger at the intake of the conveyor, and so typically comprises two sections connected by a universal joint, and mounted with the inside end of one section over the intake end of the conveyor, and sloping down to the second section lying along the floor. With a vacuum conveyor however, any grain brought close to the intake opening 6 will be sucked away, and so the configuration of the frame 7, universal joint 19 and nozzle 5 in the illustrated embodiment allows the auger 3 to move from the intake opening 6 directly along and parallel to the floor leaving much less grain behind that must be cleaned up.

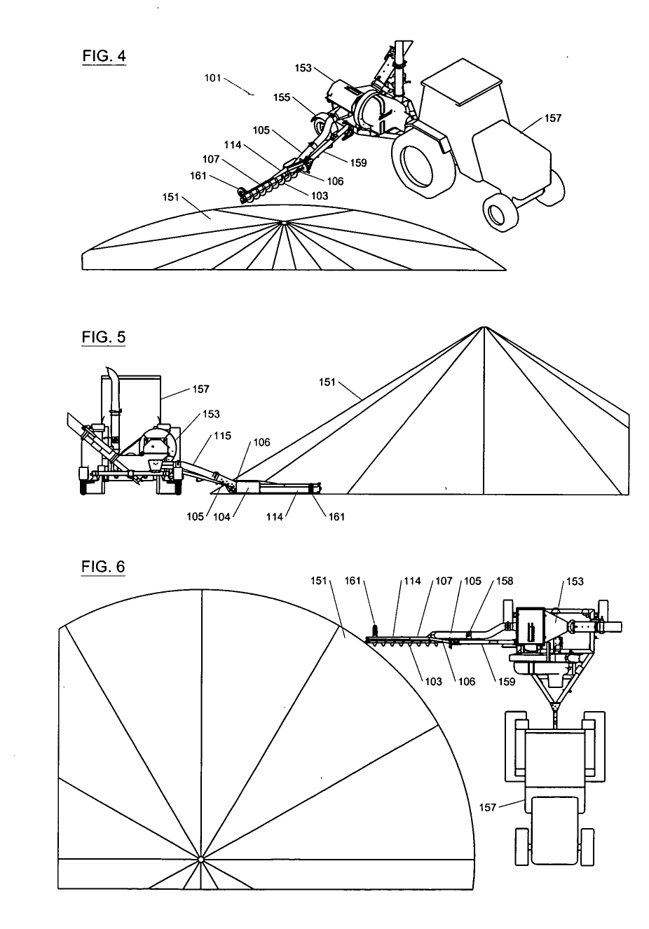

FIGS. 4-10 illustrate an embodiment of the vacuum conveyor feeding apparatus 101 of the invention for picking up a pile of grain 151 from the ground. A vacuum conveyor 153 is mounted on a trailer 155 pulled behind and powered by an agricultural tractor 157. The material conveying member is again provided by an auger 103 mounted in a frame 107 attached to the end of a feed arm 159 extending outward from the vacuum conveyor and in a substantially fixed position with respect to the vacuum conveyor 153. The auger 103 is oriented and secured in a position extending substantially straight out from the vacuum conveyor 153 and perpendicular to an operating travel direction of the vacuum conveyor. The frame 107 is supported on gauge members, illustrated as gauge wheels 161 such that the bottom of the auger 103 is just above the ground. Skids could also be used as the gauge member.

The nozzle 105 has an intake opening 106 positioned adjacent to the discharge end of the auger 103. In the illustrated embodiment the intake opening 106 is oriented upright and facing forward, such that the shroud 114 over the auger and the rear side 104 of the nozzle 105 essentially form a wall with the grain in front of it such that grain moves along the auger to the intake opening 106 and then up the nozzle 105, and does not spill out the back of the apparatus. The conduit 115 and nozzle 105 are supported by the feed arm 159, or like frame members. Alternatively inner end of the shroud could extend past flighting on the auger with a portion of the intake nozzle extending in front of the inner end of the shroud. The vacuum at the intake opening of the intake nozzle 105 will draw in grain so long as same is directed to a location in proximity to the intake opening 106. A clamp 158 can be installed to secure the intake nozzle 105 or vacuum conduit 115 to the auger frame 107 or the feed arm 159.

In operation the tractor 157 is driven alongside the grain pile 151 to move the auger 103 and if desired the intake opening 106 of nozzle 105 into the grain. As the grain is carried away the pile recedes and the tractor 157 is driven along as required to move the material conveying member, auger 103, into the grain and maintain flow into the intake opening 106. As in the embodiment of FIGS. 1-3, the auger 103 is horizontal and close to the ground to clean effectively, and the intake is oriented to also prevent grain from spilling out behind the apparatus 101.

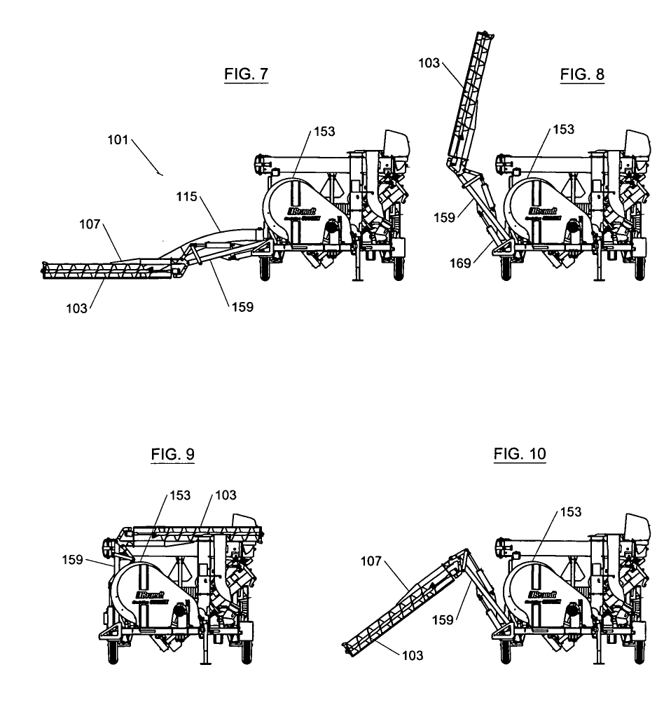

FIGS. 7-9 illustrate the feed arm 159 and material conveying member auger 103 mounted on auger frame 107 of the apparatus 101 moving from the working position of FIG. 7, extending laterally from a side of the vacuum conveyor 153 up to the partially raised position of FIG. 8 and then up to the transport position of FIG. 9 where the feed arm 159 is oriented substantially upright adjacent to the vacuum conveyor 153, and the material conveying member, auger 103, is located above the vacuum conveyor. Hydraulic cylinders 169 are arranged to move the apparatus between the transport and working positions. The vacuum conduit 115 is removed to move the apparatus 101 to the transport position.

FIG. 10 illustrates the apparatus 101 with the feed arm 159 oriented to extend upward and outward from the vacuum conveyor 153 and the auger frame 107 and auger 103 oriented to extend downward and outward from the outer end of the feed arm 159 to operate over a low wall such as is commonly used to contain grain piled on the ground.

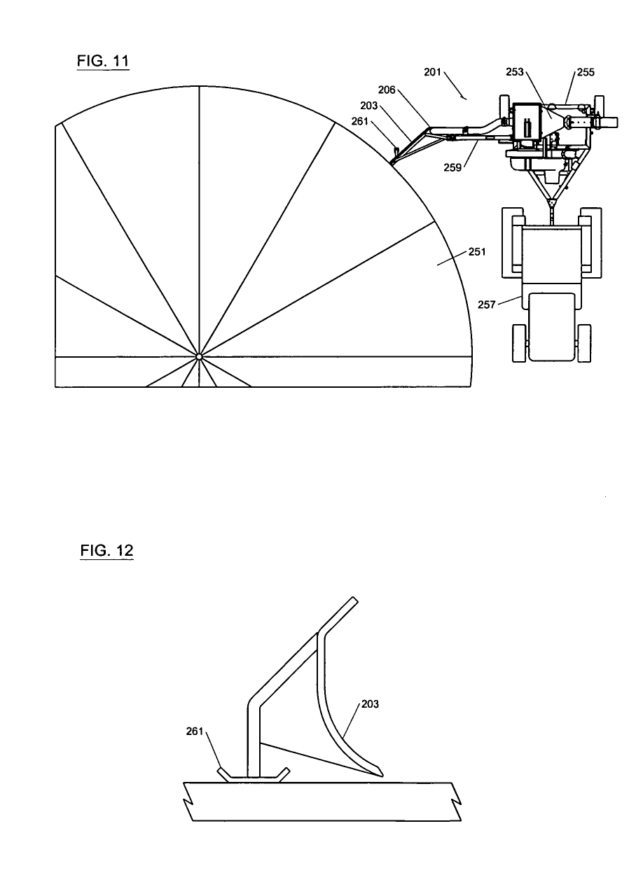

FIG. 11 illustrates an alternate embodiment of the vacuum conveyor feeding apparatus 201 of the invention for picking up a pile of grain 251 from the ground where the material conveying member comprises a scoop 203. The vacuum conveyor 253 is mounted on a trailer 255 pulled behind and powered by an agricultural tractor 257. The scoop 203 is attached to the end of feed arm 259 such that the scoop 203 is oriented and secured in a position substantially parallel with the ground and extending at an angle forward and out from the vacuum conveyor 253. As illustrated in FIG. 12, the scoop 203 is supported on gauge members provided by skids 261 such that the bottom edge of the scoop 203 is just above the ground. The bottom portion of the scoop 203 is curved or angled forward so that the scoop 203 pulls downward and remains in the grain rather than riding over the top thereof. As the tractor 257 is driven alongside the grain pile 251 the scoop 203 moves the grain toward the vacuum intake 206.

Thus the invention provides a method of feeding granular material such as grain into a vacuum conveyor. The method comprises attaching an output end of a vacuum conduit to the vacuum conveyor mounted on wheels for travel in an operating travel direction; attaching a material conveying member such as a rotating auger or scoop to an intake end of the vacuum conduit such that the auger or scoop extends outward from the intake end of the vacuum conduit in a substantially fixed position with respect to the vacuum conveyor. Moving the vacuum conveyor to move the auger or scoop through a quantity of granular material moves at least a major portion of the grain contacted by the material conveying member to the intake end of the vacuum conduit.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A vacuum conveyor feeding apparatus comprising:
a vacuum conduit having a first end thereof adapted for attachment to a suction port on a vacuum conveyor, and an intake nozzle defining an intake opening on a second end thereof;
a material conveying member extending outward from the intake end of the vacuum conduit and operative to move granular material toward the intake opening of the intake nozzle when moved through a quantity of granular material;
wherein the material conveying member is attached to the intake nozzle such that the intake nozzle moves with the material conveying member as the material conveying member moves granular material toward the intake opening.

2. The apparatus of claim 1 comprising a feed arm adapted for attachment at an inner end thereof to a vacuum conveyor mounted on wheels for movement along the ground in an operating travel direction such that the feed arm extends laterally outward from the vacuum conveyor, and wherein the material conveying member has an inner end attached to the outer end of the feed arm and extends outward from the outer end of the feed arm, and wherein the intake nozzle is mounted such that the intake opening is adjacent to the inner end of the material conveying member, and wherein the material conveying member is moved through the quantity of granular material by moving the vacuum conveyor in the operating travel direction.

3. The apparatus of claim 2 wherein the material conveying member is mounted on at least one gauge member adapted to ride along the ground and support the material conveying member above the ground.

4. The apparatus of claim 3 wherein the material conveying member comprises an auger and further comprising a motor connected to the auger to rotate the auger.

5. The apparatus of claim 4 comprising an auger frame attached at an inner end thereof to the outer end of the feed arm and wherein a discharge end of the auger is rotatably mounted in the inner end of the auger frame adjacent to the intake opening and a distal end of the auger is rotatably mounted in a distal end of the auger frame and the motor is mounted on the distal end of the auger frame.

6. The apparatus of claim 5 further comprising a shroud extending along a rear side of the auger and wherein the intake nozzle is mounted such that the intake opening is adjacent to an inner end of the shroud.

7. The apparatus of claim 6 wherein an inner end of the shroud extends past flighting on the auger and wherein a portion of the intake nozzle extends in front of the inner end of the shroud and comprising a clamp operative to secure the intake nozzle to one of the auger frame and the feed arm.

8. The apparatus of claim 5 wherein the auger frame extends outward substantially perpendicular to the operating travel direction such that as the vacuum conveyor is moved in the operating travel direction granular material in front of the auger is augered to the intake opening of the intake nozzle.

9. The apparatus of claim 2 wherein the material conveying member comprises a scoop extending outward and forward from the outer end of the feed arm such that as the vacuum conveyor is moved in the operating travel direction granular material in front of the scoop is directed along the scoop to the intake opening of the intake nozzle.

10. The apparatus of claim 1 wherein the material conveying member comprises an auger attached to the intake nozzle such that the auger is oriented in an extended position extending outward from the intake opening and substantially aligned with a longitudinal axis of the intake nozzle, and further comprising a motor connected to the auger to rotate the auger.

11. The apparatus of claim 10 wherein the auger is rotatably mounted in an auger frame pivotally attached at an inner end thereof to a side of the intake nozzle adjacent to the intake opening about a first pivot axis oriented transverse to the intake nozzle such that the auger frame can pivot from a retracted position substantially parallel to and adjacent to the intake nozzle to the extended position at which position the auger frame bears against the intake nozzle such that further movement is substantially prevented.

12. The apparatus of claim 11 wherein the auger frame is further pivotally attached to the intake nozzle about a second pivot axis oriented transverse to the first pivot axis such that the auger frame can pivot upward.

13. The apparatus of claim 11 further comprising a shroud attached to the auger frame and extending along a rear side of the auger.

14. The apparatus of claim 11 comprising a handle extending outward from the distal end of the auger frame.

15. A vacuum conveyor and feeding apparatus comprising:
a vacuum conveyor mounted on wheels for travel in an operating travel direction;
a feed arm extending laterally outward from the vacuum conveyor;
a vacuum conduit having a first end thereof attached to a suction port on the vacuum conveyor, and having an intake nozzle defining an intake opening on a second end thereof wherein the intake opening is positioned adjacent to an outer end of the feed arm;
a material conveying member extending outward from an outer end of the feed arm in a substantially fixed lateral position with respect to the vacuum conveyor and operative to move granular material toward the intake opening when moved through a quantity of granular material by moving the vacuum conveyor in the operating travel direction; and
at least one gauge member attached to the material conveying member and operative to support the material conveying member above the ground.

16. The apparatus of claim 15 wherein the material conveying member comprises an auger mounted in an auger frame attached at an inner end thereof to the outer end of the feed arm and wherein a discharge end of the auger is rotatably mounted in the inner end of the auger frame adjacent to the intake opening and a distal end of the auger is rotatably mounted in a distal end of the auger frame and a motor is mounted on the distal end of the auger frame to drive the auger.

17. The apparatus of claim 16 further comprising a shroud extending along a rear side of the auger and wherein the intake nozzle is mounted such that the intake opening is adjacent to an inner end of the shroud.

18. The apparatus of claim 16 wherein the auger frame extends outward substantially perpendicular to the operating travel direction such that as the vacuum conveyor is moved in the operating travel direction granular material in front of the auger is augered to the intake opening of the intake nozzle.

19. The apparatus of claim 16 wherein the feed arm can be oriented to extend upward and outward from the vacuum conveyor and the auger frame can be oriented to extend downward and outward from the outer end of the feed arm to operate over a wall.

20. The apparatus of claim 16 wherein the material conveying member comprises a scoop extending outward and forward from the outer end of the feed arm such that as the vacuum conveyor is moved in the operating travel direction granular material in front of the scoop is directed along the scoop to the intake opening of the intake nozzle.

21. The apparatus of claim 16 wherein the feed arm and material conveying member are movable from an operating position extending laterally from a side of the vacuum conveyor, to a transport position wherein the feed arm is oriented substantially upright adjacent to the vacuum conveyor, and the material conveying member is located above the vacuum conveyor.

22. A method of feeding granular material into a vacuum conveyor mounted on wheels for travel in an operating travel direction, the method comprising:
attaching an output end of a vacuum conduit to the vacuum conveyor;
attaching a material conveying member to an intake end of the vacuum conduit such that the material conveying member extends outward from the intake end of the vacuum conduit in a substantially fixed lateral position with respect to the vacuum conveyor;
moving the material conveying member through a quantity of granular material by moving the vacuum conveyor in the operating travel direction and thereby moving at least a major portion of the granular material to the intake end of the vacuum conduit.

23. The method of claim 22 comprising attaching the material conveying member and intake conduit to the vacuum conveyor and moving the vacuum conveyor to move the material conveying member through the quantity of granular material.

24. The method of claim 22 wherein the material conveying member comprises an auger and comprising rotating the auger as the auger moves through the quantity of granular material.

25. The method of claim 24 further comprising placing a shroud along a rear side of the auger and wherein the intake nozzle is mounted such that the intake opening is adjacent to an inner end of the shroud.

26. The method of claim 22 wherein the material conveying member comprises a scoop.

27. The method of claim 22 comprising supporting the material conveying member above the ground on at least one gauge member adapted to ride along the ground.

28. The method of claim 22 further comprising placing a shroud along a rear side of the auger and wherein the intake nozzle is mounted such that the intake opening is adjacent to an inner end of the shroud.
